(19) United States
(12) Patent Application Publication
(10) Pub. No.: US 2007/0171635 A1
(43) Pub. Date: Jul. 26, 2007

(54) Lighting device

(76) Inventor: Kai-Tai Liao, Hsinchu City (TW)

Correspondence Address: BIRCH STEWART KOLASCH & BIRCH, PO BOX 747, FALLS CHURCH, VA, 22040-0747, US

(21) Appl. No.: 11/336,996

(22) Filed: Jan. 23, 2006

(51) Int. Cl. F21L 4/04

(52) U.S. Cl. 362/199; 362/202

(57) ABSTRACT

A lighting device includes a light emitting part and a holding part. One side of the holding part includes at least a through jack and at least a catch. The size of the through jack is corresponding to the size of the catch.

### BACKGROUND OF THE INVENTION

(a) Field of the Invention

The invention relates to a lighting device, and particularly to a lighting device with an assembled structure.

(b) Description of the Related Art

FIG. 1 shows a schematic diagram illustrating a conventional flashlight 10. The flashlight 10 provides constant brightness and a fixed irradiation area. It is inconvenient for a lighting device without adjustable brightness and adjustable irradiation area.

Therefore, it is in great demand to provide a lighting device having adjustable brightness and irradiation area to increase its usability.

### BRIEF SUMMARY OF THE INVENTION

In light of the above-mentioned matter, an object of the invention is to provide a lighting device capable of being assembled to each other and disassembled in a simple manner so as to have arbitrarily adjustable brightness and an adjustable irradiation area for users.

The present invention provides a lighting device comprising a light emitting part and a holding part. The light emitting part is provided for emitting lights. The holding part connected to the light emitting part wherein one side of the holding part includes at least a through jack and at least a catch and the size of the through jack is corresponding to the size of the catch. Therefore, a plurality of the lighting devices according to the present invention are connected to each other by assembling the through jack and the catch. Moreover, after assembled together, these lighting devices can be easily detached from each other without any auxiliary tool.

Furthermore, the present invention provides an assembling member comprising a first assembling element and a second assembling element. The first assembling element and the second assembling element may have the same or different structures. The assembling elements have slab structures and utilize a movable joint or hinge to be connected with each other and each assembling element includes at least a through jack for being assembled with the catch of the holding part and at least a catch for being assembled with the through jack of the holding part. By utilizing the assembling member, the variety of the lighting device combinations is increased so as to broaden the application of the lighting devices.

The lighting device according to the present invention utilizes the through jack and the catch of the holding part having the capabilities of being assembled to each other and easily disassembled so as to assemble two or more than two lighting devices together. Therefore, the number of the assembled lighting devices is adjustable in a simple manner to have adjustable brightness and an adjustable irradiation area for users. Moreover, a plurality of the lighting devices can be assembled to form an artistic pattern to gain attraction by the through jack and the catch so as to increase product value.

### BRIEF DESCRIPTION OF THE DRAWINGS

FIG. 1 shows a schematic diagram illustrating a conventional flashlight.

FIG. 2A shows a side view of the lighting device according to an embodiment of the invention.

FIG. 2B shows a rear side view of the lighting device according to an embodiment of the invention.

FIG. 3A shows a schematic diagram illustrating the combination of assembling three lighting devices of the invention.

FIG. 3B shows a front view illustrating the combination of assembling three lighting devices of the invention.

FIG. 3C shows a rear view illustrating the combination of assembling three lighting devices of the invention.

FIG. 4 shows a schematic diagram illustrating the combination of assembling seven lighting devices of the invention.

FIG. 5A shows a schematic diagram illustrating the lighting device according to another embodiment of the invention.

FIG. 5B shows a schematic diagram illustrating the assembling portion of the through jack of one lighting device and the catch of the other lighting device.

FIG. 6 shows a schematic diagram illustrating an assembling member according to the invention.

FIG. 7A shows a schematic diagram illustrating the combination of assembling the assembling member and the holding part of the lighting device.

FIG. 7B shows a schematic diagram illustrating the combination of assembling the assembling member and two lighting devices.

FIGS. 8A to 8D show schematic diagrams illustrating another assembling member according to the invention.

FIG. 9 shows a schematic diagram illustrating another lighting equipment according to the invention.

FIGS. 10A to 10E show schematic diagrams illustrating another lighting equipment according to the invention.

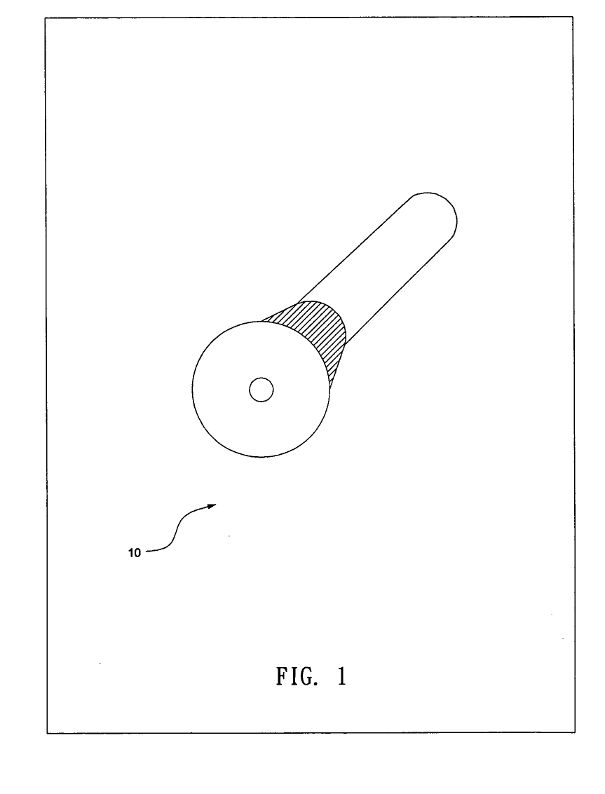

### DETAILED DESCRIPTION OF THE INVENTION

Detail descriptions of the structure and elements according to the invention will be provided in the following together with figures in order to make the invention thoroughly understood. The same elements in figures will be denoted by the same symbols.

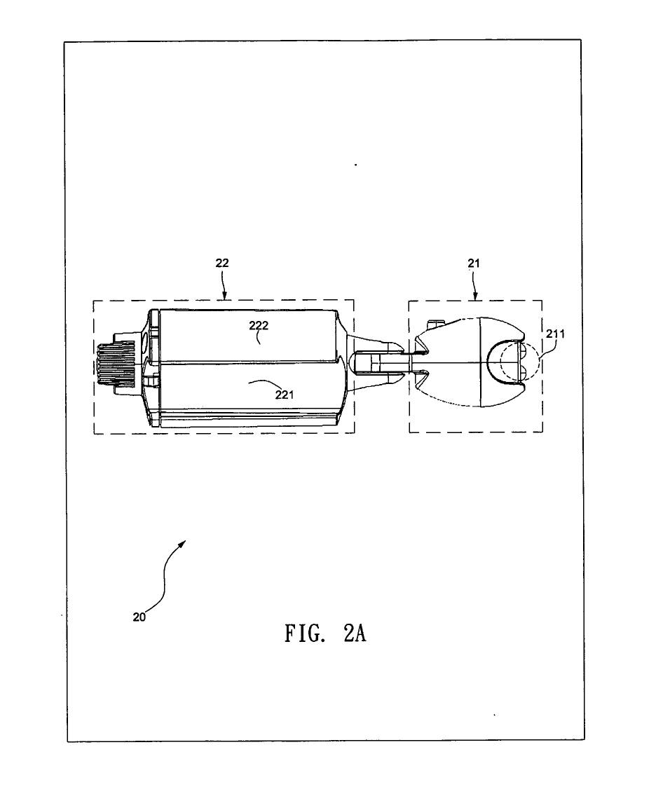

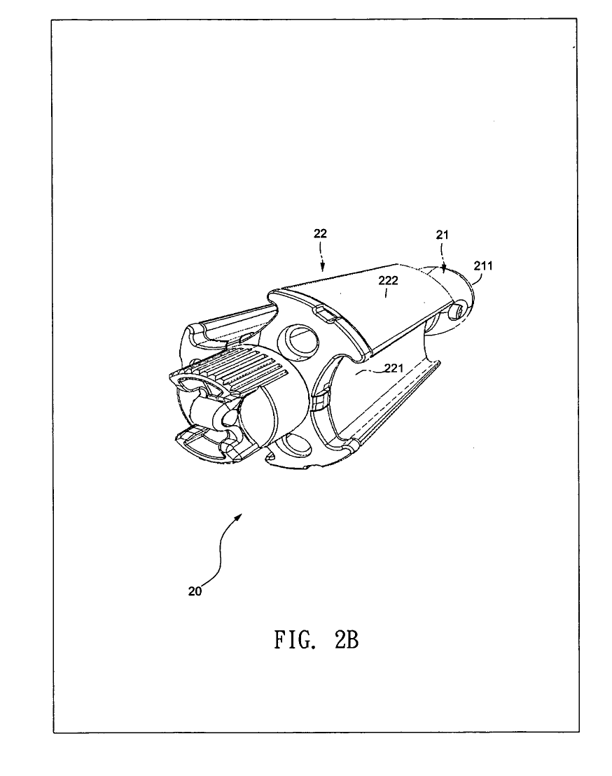

FIG. 2A shows a side view of the lighting device 20 according to an embodiment of the invention while FIG. 2B shows a rear side view of the lighting device 20. As shown in FIGS. 2A and 2B, the lighting device 20 comprises a light emitting part 21 and a holding part 22. The light emitting part 21 includes a light source 211 that can be selected from a group consisting of the following: light emitting diode (LED), high power light emitting diode, tungsten lamp, halide lamp, neon lamp and their combinations. The LED can be selected from a group consisting of the following: white, blue, red, green, far-infrared light emitting diodes and their combinations. The light irradiated from the light emitting part 21 by the light source 211 is controlled by a control circuit (not shown) to have different intensities, colors, and flashing states.

The holding part 22 is connected to the light emitting part 21. They are connected by a stationary way or by a movable joint. While using a movable joint, the light emitting part 21 can be rotated (0˜360°) through the movable joint by manpower or a programmable driving motor. The holding part 22 receives alternating current (AC) or direct current (DC) as the power source of the light emitting part 21. The interior of the holding part 22 can be designed to accommodate such as batteries (not shown), a transformer (not shown) or their combination. The batteries may be Li batteries, conventional batteries, and rechargeable batteries. The transformer is provided to transform AC to DC to supply electric power to the light emitting part 21. Obviously, the transformer can be provided at the outside of the holding part 22, such as on the power cord. One side of the holding part 22 includes three through jacks 221 and three catch 222 and the size of the through jack 221 is corresponding to the size of the catch 222. Besides, the through jack 221 and the catch 222 are of detachable mechanism so as to have the easily detachable function.

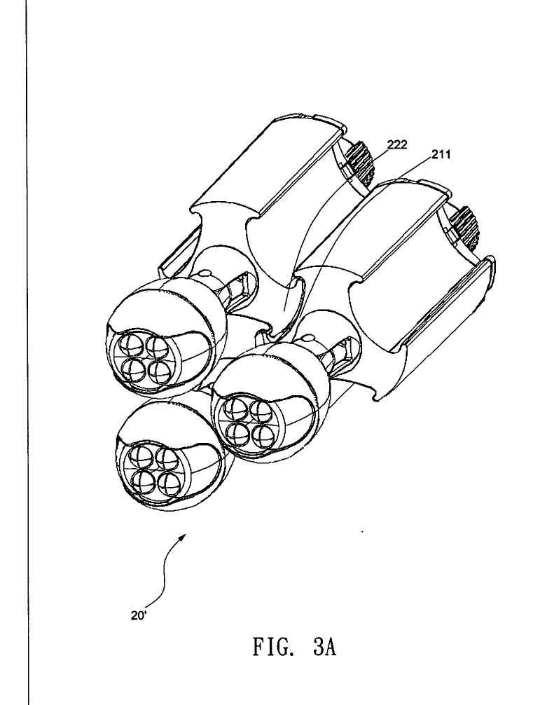

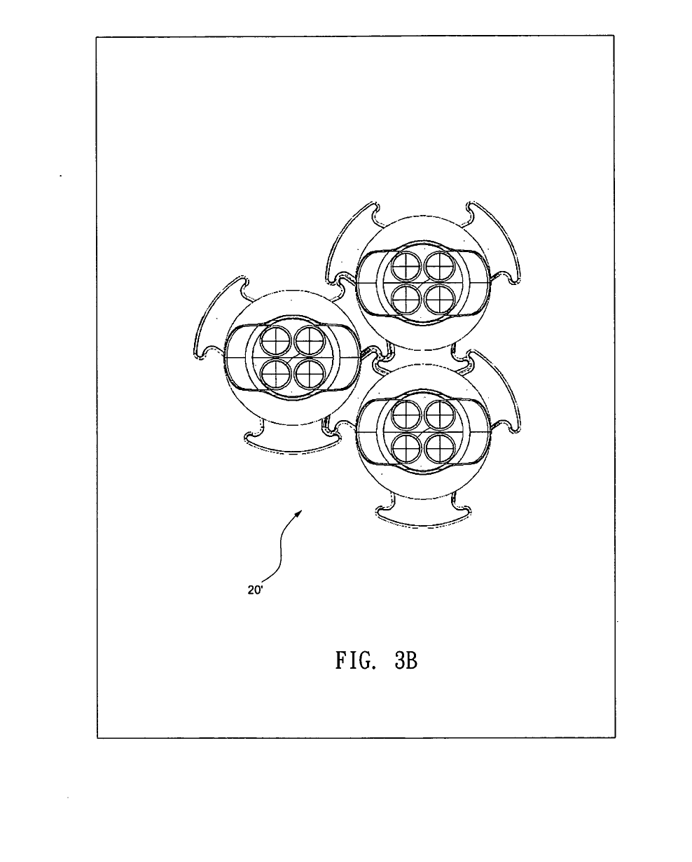

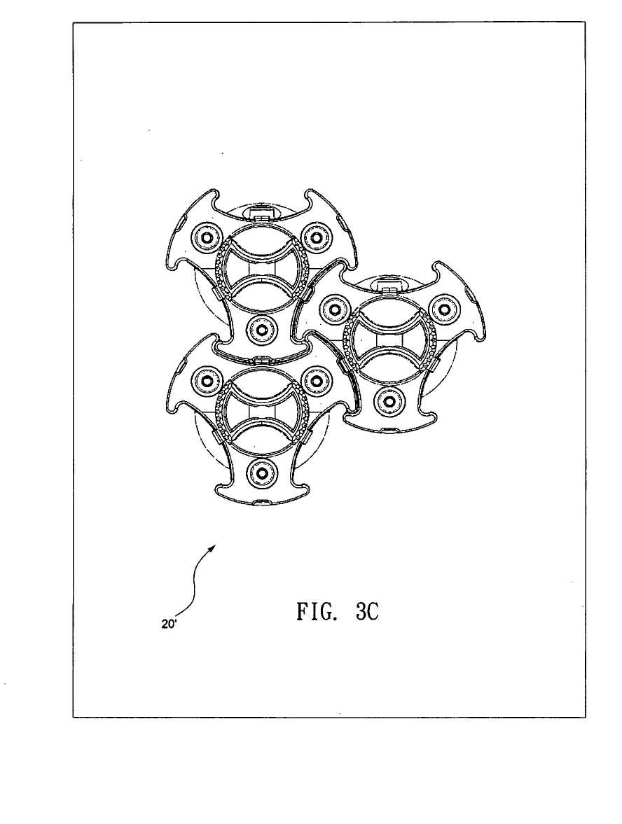

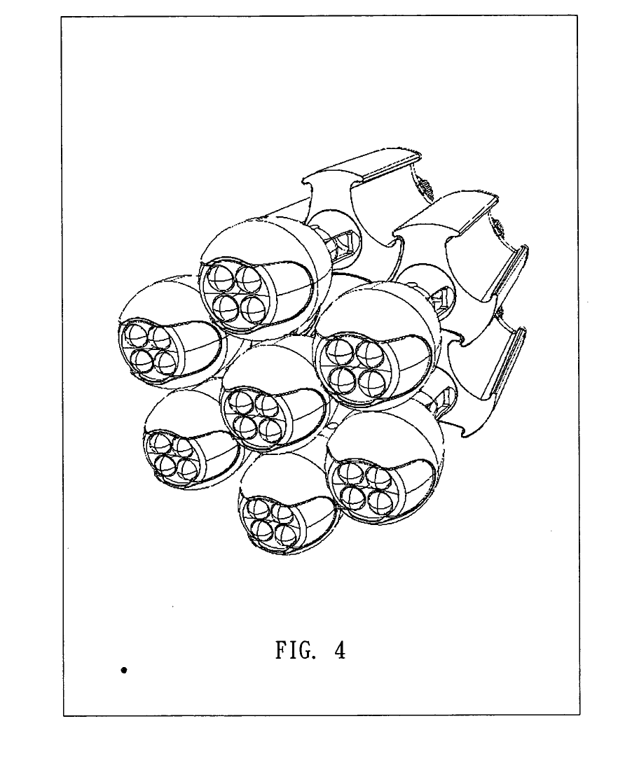

FIG. 3A shows a schematic diagram illustrating the combination of assembling three lighting devices of the invention. FIGS. 3B and 3C shows a front view and a rear view of the combination of assembling three lighting devices, respectively. Three lighting devices 20 are connected to each other by assembling the through jacks 221 and the catches 222 to form a lighting equipment 20′ including three lighting devices 20. Apparently, due to the detachable characteristic of the through jack 221 and the catch 222, the lighting device 20 can be directly disassembled from the lighting equipment 20′ for other purpose. Besides, in the case of each lighting device 20 having the same brightness and irradiation area, the brightness and the irradiation area of the whole lighting equipment 20′ become about three times of the lighting device 20. Because the lighting device 20 including three through jacks and three catches can be connected to other lighting devices by the through jacks and the catches, the number of the lighting devices connected together can be infinity. For example, FIG. 4 shows a schematic diagram illustrating the combination of assembling seven lighting devices. The size, quantities and structure of the through jack 221 and the catch 222 can be adjusted. For example, the quantities of the through jack 221 and the catch 222 can be one or five, etc., as long as two lighting devices 20 can be connected steadily.

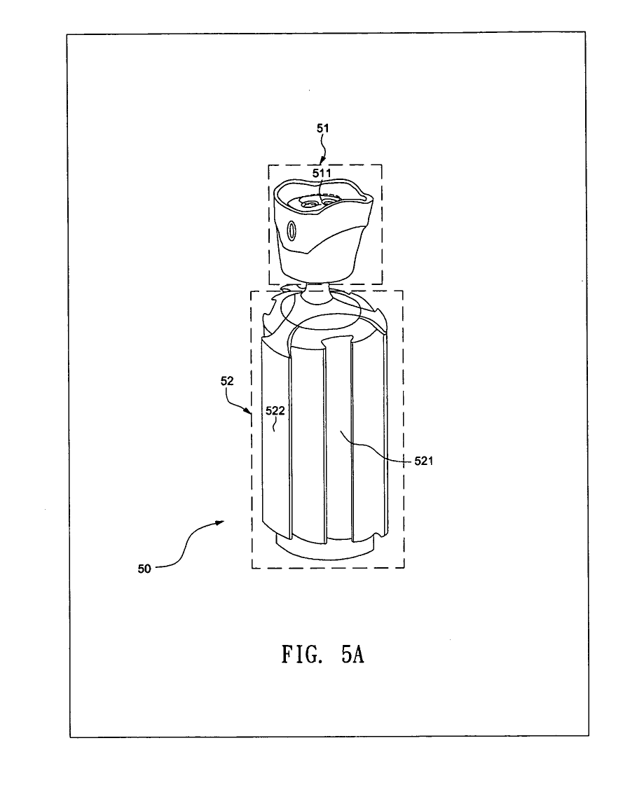

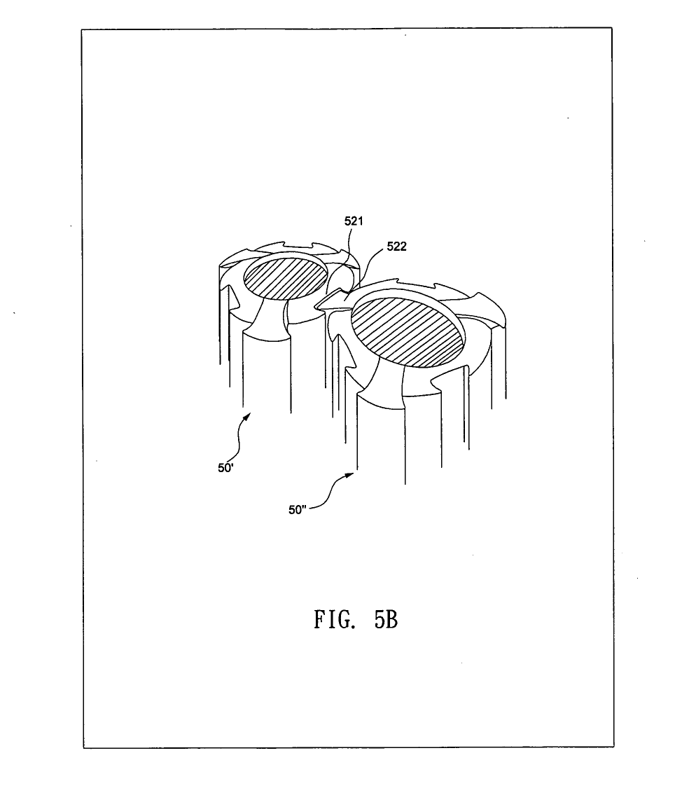

FIG. 5A shows a schematic diagram illustrating the lighting device according to another embodiment of the invention. The lighting device 50 comprises a light emitting part 51 and a holding part 52. The light emitting part 51 includes a light source 511. The holding part 52 includes three through jacks 521 and three catches 522. A shown in the figure, the sizes of the through jacks 521 and the catches 522 are smaller than those of the through jacks 221 and the catches 222 shown in FIG. 2A in order to modify the design of the lighting device 50. The structures of the through jack and the catch of the lighting device 50 are designed to be different from those of the lighting device 20. The structure of the lighting device 50 still has the function of easily assembling and disassembling a plurality of the lighting devices 50. FIG. 5B shows a schematic diagram illustrating the assembling portion of the through jack 521 of the lighting device 50′ and the catch 522 of the lighting device 50″.

The lighting device can be used as a portable device like a conventional flashlight or as interior or exterior lighting device like a flicker lamp or exhibition lamp because of the convenient design of the power source. The quantities of the lighting devices can be either increased or decreased to meet the brightness requirement. Therefore, the lighting device according to the invention resolves the problem of incapability of adjustment in brightness and irradiation area for a conventional flashlight. In addition, it provides more functionality.

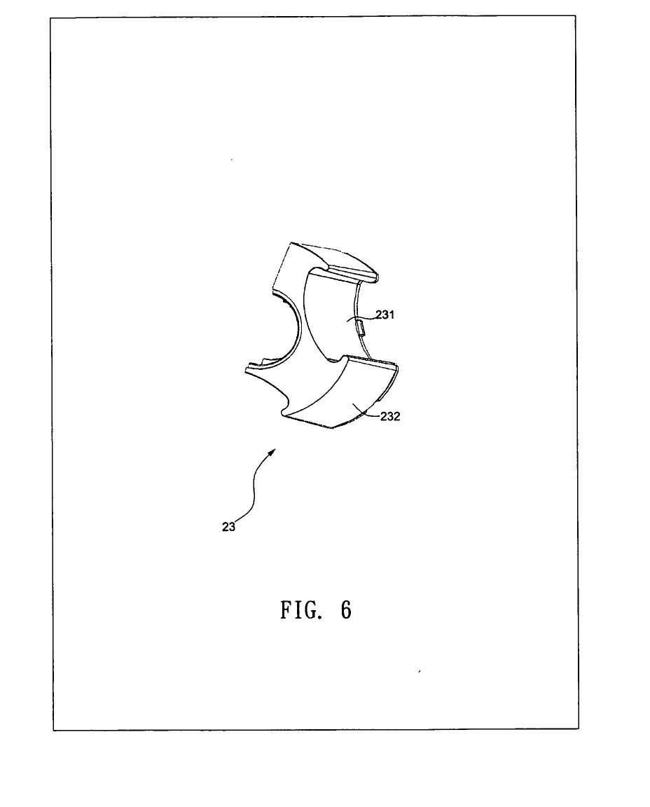

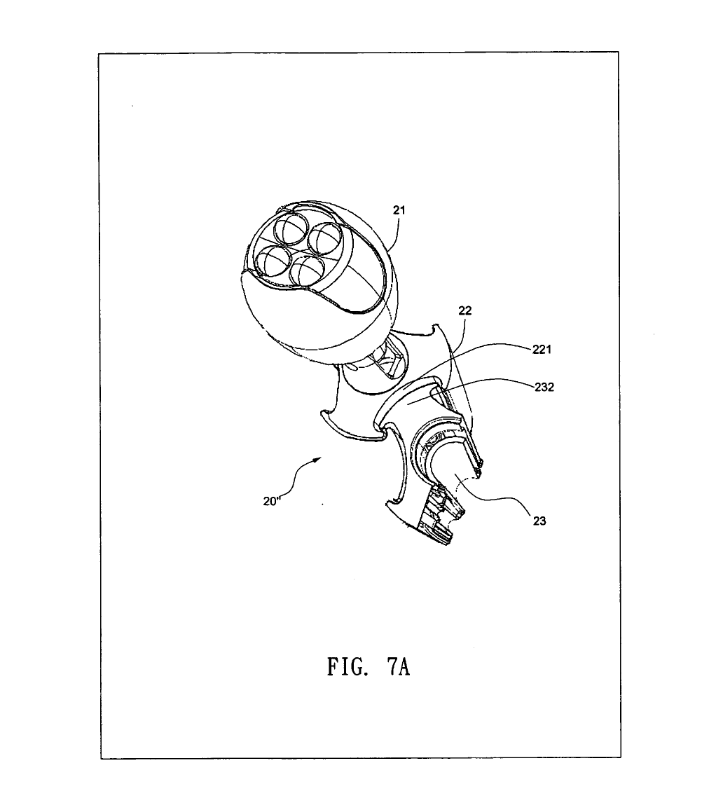

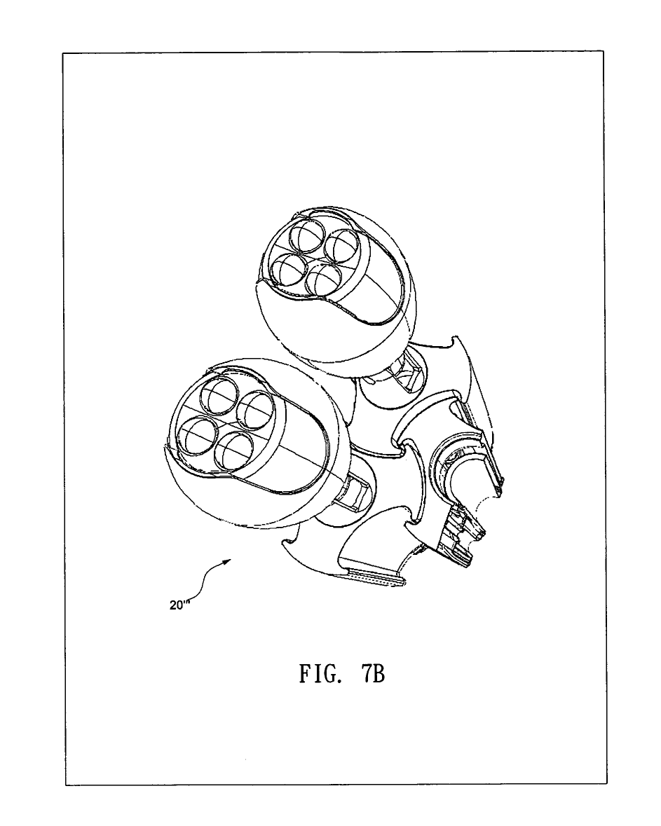

On the other hand, as shown in FIG. 6, the lighting device 20 further comprises an assembling member. The assembling member 23 can be fixed to any location, such as a ceiling, a bike and a suitcase. The assembling member 23 is provided for being assembled with the holding part 22 of the lighting device 20. The assembling member 23 includes a through jack 231 and a catch 232. Obviously, the quantities of the through jack 231 and the catch 232 of the assembling member 23 can be altered and is not limited to the above-mentioned quantities. For example, the assembling member 23 may include five through jacks and two catches. The through jack 231 of the assembling member 23 is assembled with the catch 222 of the holding part 22. Besides, the catch 232 of the assembling member 23 is assembled with the through jack 221 of the holding part 22. The through jack 231 and the catch 222 or the catch 232 and the through jack 221 are directly detachable after being assembled together. FIG. 7A shows the state of assembling the assembling member 23 and the holding part 22 of the lighting device 20 together. It should be noted that the device comprising the assembling member 23 and the lighting device 20 is defined as another lighting device 20″. FIG. 7B shows another lighting device 20′″ comprising the lighting device 20″ and another lighting device 20.

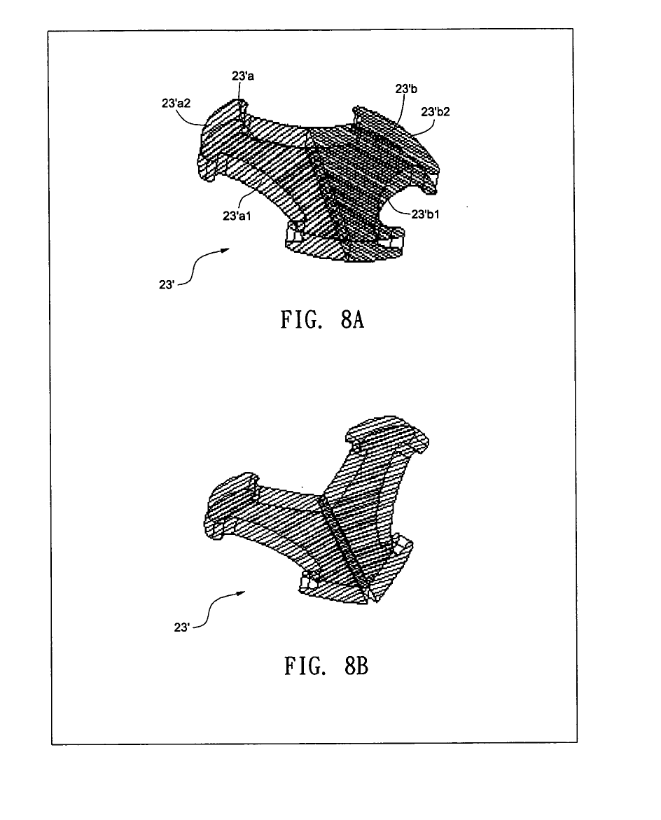

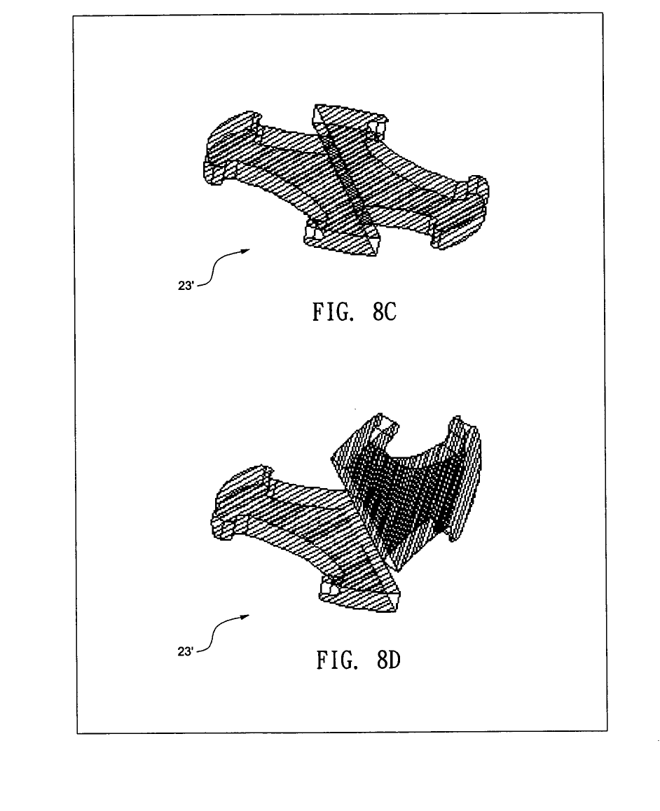

FIG. 8A shows a schematic diagram illustrating another assembling member 23′ according to the invention. The assembling member 23′ includes a first assembling element 23′a and a second assembling element 23′b. The assembling elements 23′a and 23′b have slab structures and utilize a movable joint or hinge to be connected with each other so as to be movable in 0˜180° or 0˜360°. As shown in FIG. 8B, the assembling elements 23′a and 23′b are in a state of being folded toward each other. As shown in FIG. 8C, the assembling elements 23′a and 23′b are in a state of being turned 180 degrees and then folded. As shown in FIG. 8D, the assembling elements 23′a and 23′b are in a state of being folded toward each other and turned 180 degrees. Besides, each assembling element 23′a (23′b) includes a through jack 23′a1 (23′b1 ) and a catch 23′a2 (23′b2). The catch 23′a2 (23′b2) is provided for being assembled with the catch 222 of the holding part 22. The through jack 23′a1 (23′b1) is provided for being assembled with the through jack 221 of the holding part 22. Apparently, the number of the through jacks and the catches can be adjusted as required. For example, the assembling element 23′a may have three through jacks and three catches and the assembling element 23′b may have five through jacks and five catches. In addition, the through jacks 23′a1, 23′b1 and 221 and the catches 23′a2, 23′b2 and 222 are directly detachable without any auxiliary tool after being assembled together.

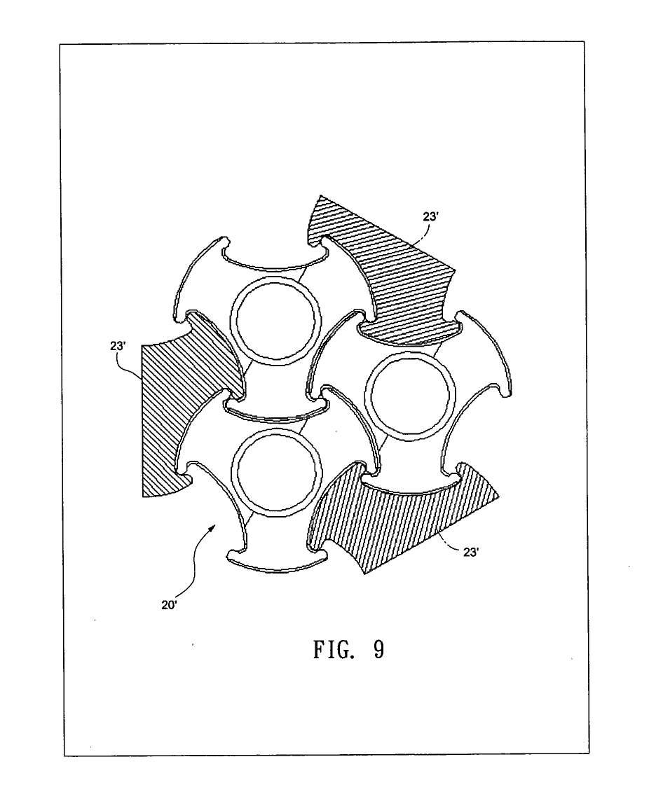

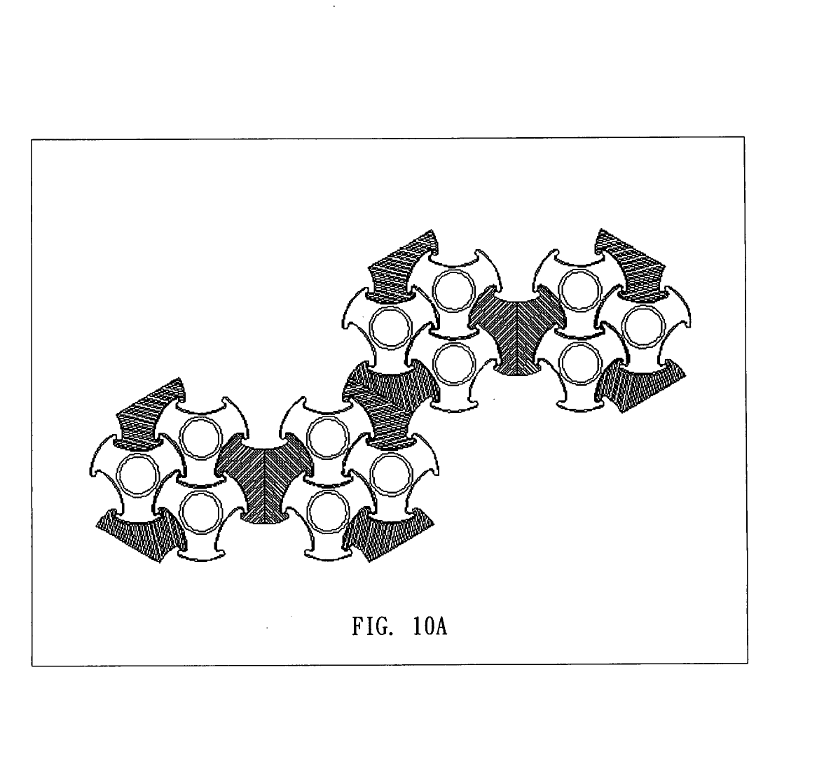

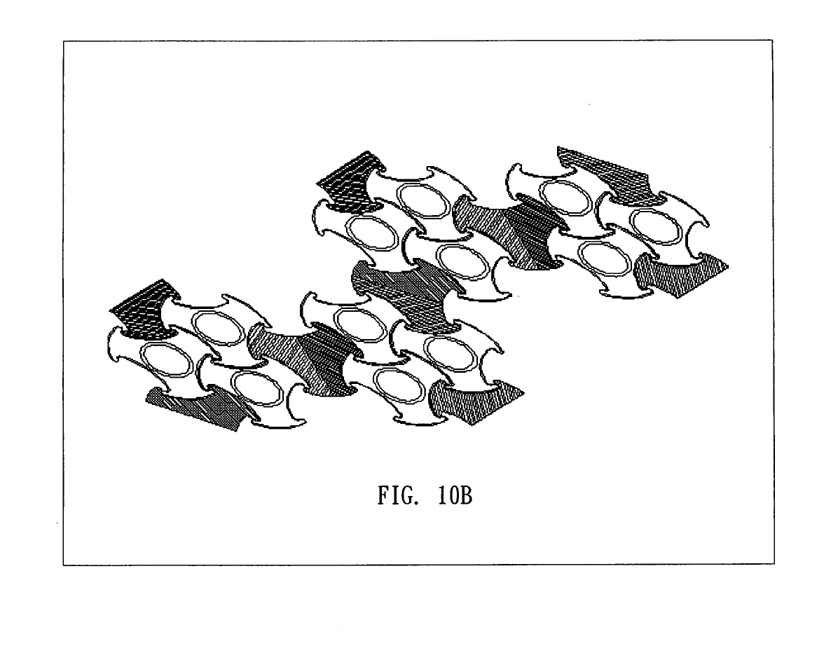

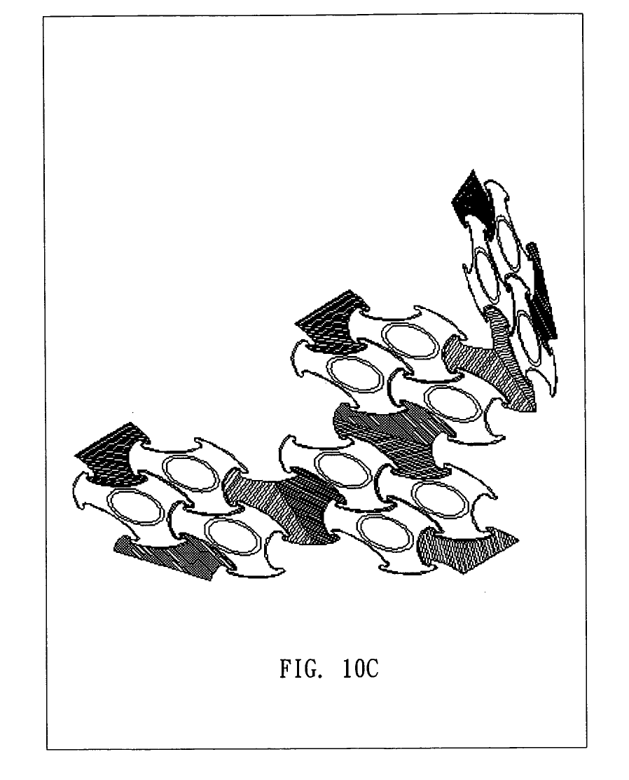

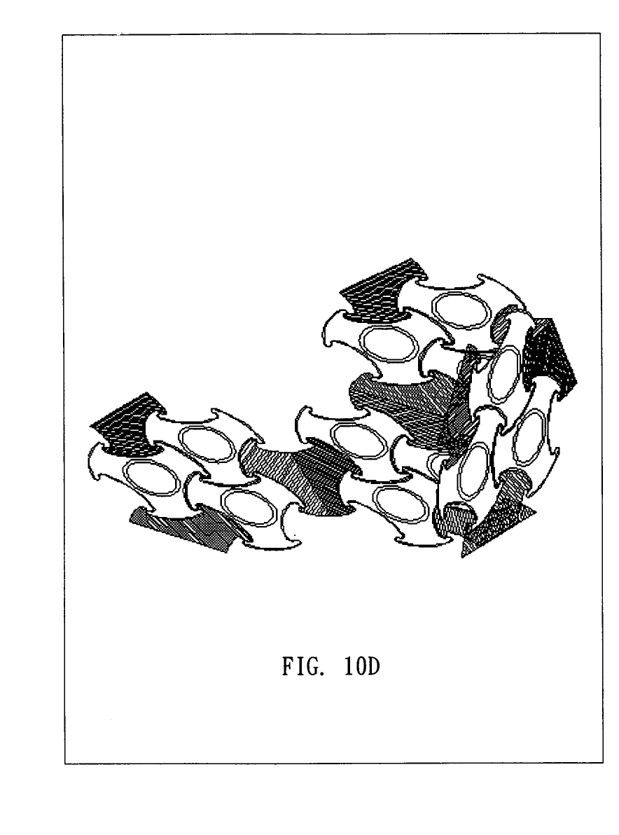

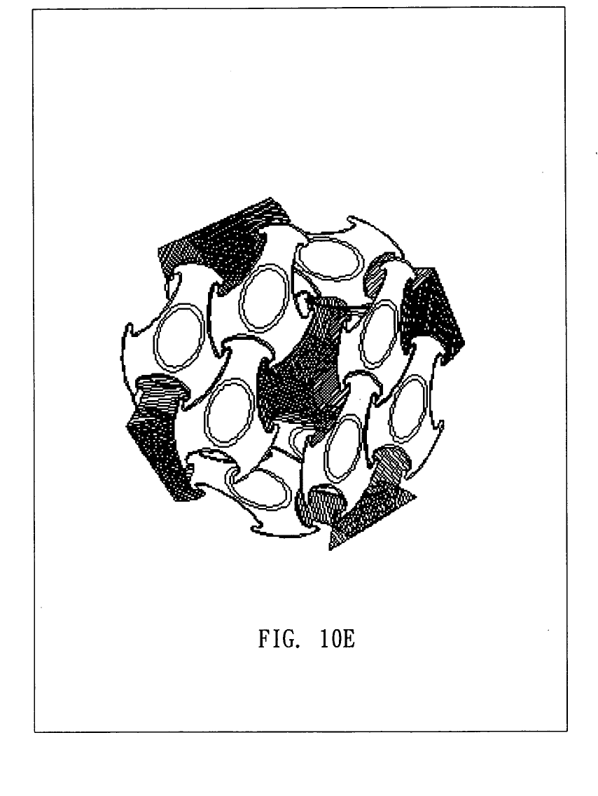

In order to further illustrate the variety of the combinations between the lighting device 20 and the assembling member 23′, FIG. 9 and FIGS. 10A-10E do not show the light emitting part 21 of the lighting device 20. FIG. 9 shows the combination of assembling three lighting devices 20 and three assembling members 23′. Combining a plurality of the devices shown in FIG. 9 becomes the device shown in FIG. 10A. By the movable joint or hinge of the assembling member 23′, the form of the lighting equipment can be varied. For example, as shown in FIGS. 10B˜10E, the lighting equipment has a shape of pyramid so as to increase its application field.

In the embodiment, the AC circuit, signal control circuit, and energy storage device are provided in the holding part. These circuits and the device can be provided in the assembling member for another embodiment. In addition, the lighting device according to the invention can be designed to have the functions of weatherproof, such as water-resistance and moisture-resistance, etc.

While the invention has been described by way of examples and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A lighting device, comprising:
a light emitting part for emitting lights; and,
a holding part connected to the light emitting part;
wherein one side of the holding part includes at least a through jack and at least a catch and the size of the through jack is corresponding to the size of the catch.

2. The lighting device as claimed in claim 1, wherein the through jack is provided to be assembled with the catch.

3. The lighting device as claimed in claim 1, wherein the through jack and the catch are detachable after being assembled together.

4. The lighting device as claimed in claim 1, wherein the holding part receives alternating current or direct current as the power source of the light emitting part.

5. The lighting device as claimed in claim 1, wherein the light emitting part further comprises a light source selected from a group consisting of the following: light emitting diode, high power light emitting diode, tungsten lamp, halide lamp, neon lamp and their combinations.

6. The lighting device as claimed in claim 1, wherein the light emitting diode is selected from a group consisting of the following: white, blue, red, green, far-infrared light emitting diodes and their combinations.

7. The lighting device as claimed in claim 1, further comprising:
an assembling member with slab structure including at least a through jack and at least a catch wherein the catch of the assembling member is provided for being assembled with the through jack of the holding part and the through jack of the assembling member is provided for being assembled with the catch of the holding part.

8. The flash light as claimed in claim 7, wherein the catch and the through jack are detachable after being assembled together.

9. The lighting device as claimed in claim 1, further comprising:
an assembling member including a first assembling element and a second assembling element wherein the assembling elements have slab structures and utilize a movable joint or hinge to be connected with each other and each assembling element includes at least a through jack for being assembled with the catch of the holding part and at least a catch for being assembled with the through jack of the holding part.

10. The lighting device as claimed in claim 9, wherein the catch and the through jack are detachable after being assembled together.

11. The lighting device as claimed in claim 1, wherein the light emitting part is rotated by manpower, a wire or wireless programmable driving motor.

12. A lighting equipment, comprising:
a plurality of lighting devices, each lighting device including
a light emitting part for emitting lights; and,
a holding part connected to the light emitting part wherein one side of the holding part includes at least a through jack and at least a catch and the size of the through jack is corresponding to the size of the catch;
wherein the lighting devices are assembled to each other by connecting one's through jack with the other's catch.

13. The lighting equipment as claimed in claim 12, wherein the catch and the through jack are detachable after being assembled together.

14. The lighting equipment as claimed in claim 12, wherein the holding part receives alternating current or direct current as the power source of the light emitting part.

15. The lighting equipment as claimed in claim 12, wherein the light emitting part further comprises a light source selected from a group consisting of the following: light emitting diode, high power light emitting diode, tungsten lamp, halide lamp, neon lamp and their combinations.

16. The lighting equipment as claimed in claim 12, further comprising:
an assembling member with slab structure including at least a through jack and at least a catch wherein the catch of the assembling member is provided for being assembled with the through jack of the holding part and the through jack of the assembling member is provided for being assembled with the catch of the holding part.

17. The lighting equipment as claimed in claim 16, wherein the catch and the through jack are detachable after being assembled together.

18. The lighting equipment as claimed in claim 12, further comprising:
an assembling member including a first assembling element and a second assembling element wherein the assembling elements have slab structures and utilize a movable joint or hinge to be connected with each other and each assembling element includes at least a through jack for being assembled with the catch of the holding part and at least a catch for being assembled with the through jack of the holding part.

19. The lighting equipment as claimed in claim 18, wherein the catch and the through jack are detachable after being assembled together.

20. The lighting equipment as claimed in claim 12, wherein the light emitting part is rotated by manpower, a wire or wireless programmable driving motor.
